(19) United States
(12) Patent Application Publication
(10) Pub. No.: US 2024/0150176 A1
(43) Pub. Date: May 9, 2024

(54) NASICON-TYPE FLUOROPHOSPHATE, CATHODE electrode plate AND sodium-ion BATTERY

(71) Applicant: JIANGSU ZENERGY BATTERY TECHNOLOGIES CO., LTD., Jiangsu (CN)

(72) Inventors: Di WANG, Jiangsu (CN); Yingnan DONG, Jiangsu (CN); Jizong ZHANG, Jiangsu (CN)

(21) Appl. No.: 18/386,596

(22) Filed: Nov. 2, 2023

(30) Foreign Application Priority Data
Nov. 3, 2022 (CN) 202211372482.4

(51) Int. Cl. C01B 25/455; H01M 10/36

(52) U.S. Cl. CPC C01B 25/455; H01M 10/36

(57) ABSTRACT

The present disclosure relates to the field of energy materials, and discloses a NASICON-type fluorophosphate with a molecular formula Na₃MₓV₂N_{y}P_{3-y}O₁₂F_{z}. M is at least one of Li, Na, K, Ni, Fe, Ca, Ti, Cr, Zn, Ag, Mo, Mg and Mn. N is at least one of B, Si, Ge and As. 0≤x≤4, 0≤y≤3, 0≤z≤1, and x=y+z. In embodiments, by introducing M and N, and ionic synergy of M, N and fluorine, the formed NASICON-type fluorophosphate material has greatly improved conductivity, which is conducive to improve coulombic efficiency and high-rate performance of sodium-ion batteries. The present disclosure further discloses a cathode electrode plate and a sodium-ion battery. The cathode electrode plate includes the NASICON-type fluorophosphate.

### CROSS-REFERENCE TO RELATED APPLICATIONS

This application is based on Chinese Patent Application No. 202211372482.4, filed Nov. 3, 2022, which claims the benefit of priority to the Chinese Patent Application, which is incorporated by reference in its entirety herein.

### TECHNICAL FIELD

The present disclosure relates to the field of energy materials, and in particular to a NASICON-type fluorophosphate, a cathode electrode plate and a sodium-ion battery.

### BACKGROUND

With the increasing demand for lithium-ion batteries, the demand for lithium mining has increased, and the price of limited lithium mineral resources is increasing. Compared with the scarcity of lithium, sodium is abundant and inexhaustible, and is expected to replace lithium-ion batteries. Therefore, the study of sodium-ion batteries will be a very promising research direction.

In a sodium-ion battery system, the cathode material is the key factor affecting the performance and cost of the battery. Among the cathode materials currently studied, the novel NASICON-type sodium vanadium phosphate (NVP) material has excellent stability and relatively high energy density. However, the directly synthesized NVP cathode material is limited in electrochemical performance, especially conductivity and high-rate long-term cycling performance, so many pioneers in scientific research are thinking about how to solve this problem. Currently, one solution is to coat nano NVP with carbon. The carbon-coated nano NVP has higher conductivity, but lower coulombic efficiency and cycling stability, and thus, has poor comprehensive electrochemical performance, making it still need to be improved a lot.

In view of this, it is necessary to provide a NASICON-type fluorophosphate, a cathode and a battery with better electrochemical performance, so as to further improve electrochemical performance of sodium ion batteries.

### SUMMARY

An objective of the present disclosure is to provide a NASICON-type fluorophosphate, a cathode electrode plate and a sodium-ion battery, which are conducive to further improve electrochemical performance of sodium-ion batteries.

Provided is a NASICON-type fluorophosphate with a molecular formula Na₃MₓV₂N_{y}P_{3-y}O₁₂F_{z}. M is at least one of Li, Na, K, Ni, Fe, Ca, Ti, Cr, Zn, Ag, Mo, Mg and Mn. N is at least one of B, Si, Ge and As. 0≤x≤4, 0≤y≤3, 0≤z≤1, and x=y+z.

In some embodiments, the NASICON-type fluorophosphate is further coated with carbon to obtain a material Na₃MₓV₂N_{y}P_{3-y}O₁₂F_{z}@C.

Further provided is a method for preparing a NASICON-type fluorophosphate, including the following steps:
S01: uniformly mixing a pentavalent vanadium salt, a sodium salt, an M-containing compound, an N-containing compound, a phosphate and a fluoride salt in a container to form a mixture; and
S02: exposing the mixture to a reducing gas, and carrying out plasma heating on the mixture to obtain the NASICON-type fluorophosphate with a molecular formula Na₃MₓV₂N_{y}P_{3-y}O₁₂F_{z}. M is at least one of Li, Na, K, Ni, Fe, Ca, Ti, Cr, Zn, Ag, Mo, Mg and Mn. N is at least one of B, Si, Ge and As. 0≤x≤4, 0≤y≤3, 0≤z≤1, and x=y+z.

In some embodiments, in step S01, a mole ratio of the pentavalent vanadium salt to the sodium salt to the M-containing compound to the N-containing compound to the phosphate to the fluoride salt is 0.01-2:0.01-3:0.01-1:0.01-3:0.01-3:0.01-1.

In some embodiments, during the uniform mixing in step S01, an additive is further added to the container. The additive includes at least one of citric acid, glucose, sucrose, amino acid and urea.

In some embodiments, the additive includes glucose and amino acid, and a ratio of the glucose to the amino acid in the additive is 1:0.6-1.5;
or
the additive includes sucrose and citric acid, and a ratio of the sucrose to the citric acid in the additive is 1:0.5-1.8.

In some embodiments, the reducing gas includes nitrogen, hydrogen and a protective gas. The protective gas includes at least one of helium, neon and argon.

A volume percentage of the hydrogen is greater than 0% and smaller than or equal to 15%, and a volume percentage of the protective gas is greater than or equal to 85% and smaller than 100%.

Further provided is a cathode electrode plate, including the NASICON-type fluorophosphate prepared by the method as described above.

Further provided is a sodium-ion battery, including the cathode electrode plate as described above.

In some embodiments, M is at least one of Li and K.

In some embodiments, N is at least one of Si and B.

In some embodiments, M is Li, N is Si.

In some embodiments, 0.5≤x≤4, 0.2≤y≤3, 0.2≤z≤1, and x=y+z.

In some embodiments, 0.5≤x≤0.91, 0.2≤y≤0.5, 0.2≤z≤0.65, and x=y+z.

In some embodiments, the fluorophosphate is Na₃Li_{0.8}V₂Si_{0.5}P_{2.5}O₁₂F_{0.3}, Na_{3.5}V₂Si_{0.3}P_{2.7}O₁₂F_{0.2}, Na₃K_{0.91}V₂B_{0.26}P_{2.74}O₁₂F_{0.65}, Na₃Li_{0.5}V₂Si_{0.2}P_{2.7}O₁₂F_{0.3}, Na₃K_{0.5}V₂Si_{0.3}P_{2.7}O₁₂F_{0.2} or Na₃Li₄V₂Si₃O₁₂F.

In some embodiments, the fluorophosphate is Na₃Li_{0.8}V₂Si_{0.5}P_{2.5}O₁₂F_{0.3}@C, Na₃Li_{0.5}V₂Si_{0.2}P_{2.8}O₁₂F_{0.3}@C or Na₃K_{0.91}V₂B_{0.26}P_{2.74}O₁₂F_{0.65}@C.

Compared with the prior art, the present disclosure has the following beneficial effects:

The Na₃MₓV₂N_{y}P_{3-y}O₁₂F_{z} in the present disclosure can effectively broaden the material lattice structure. Moreover, under the ionic synergy of M, N and fluorine, the formed NASICON-type fluorophosphate material has greatly improved conductivity and improved structural stability, which is conducive to improve the coulombic efficiency and high-rate performance of the sodium-ion batteries, and effectively improves the electrochemical performance of the batteries.

### BRIEF DESCRIPTION OF THE DRAWINGS

In order to more clearly illustrate the examples of the present disclosure or the technical solutions in the prior art, the accompanying drawings used in the description of the examples or the prior art will be briefly described below. Apparently, the accompanying drawings in the following description are only some examples of the present disclosure, and those of ordinary skill in the art can obtain other drawings according to these drawings without any creative work.

The structure, scale and size shown in the accompanying drawings of this specification are intended to be used in conjunction with the contents disclosed in this specification for people familiar with this technology to understand and read, and not to limit the conditions for the embodiment of the present disclosure, and therefore do not have any technical significance. Any modification of the structure, change of the scale, or adjustment of the size shall still fall within the scope of the technical contents disclosed in the present disclosure without affecting the efficacy and objectives that can be achieved by the present disclosure.

FIG. 1 shows first-cycle charge/discharge curves of the Na₃Li_{0.8}V₂Si_{0.5}P_{2.5}O₂F_{0.3} cathode material in a sodium-ion battery according to an example of the present disclosure;

FIG. 2 shows first-cycle charge/discharge curves of the Na₃Li_{0.8}V₂Si_{0.5}P_{2.5}O₁₂F_{0.3}@C cathode material in a sodium-ion battery according to an example of the present disclosure; and

FIG. 3 shows a SEM (scanning electron microscope) image of the Na₃Li_{0.8}V₂Si_{0.5}P_{2.5}O₁₂F_{0.3}@C cathode material according to an example of the present disclosure.

### DETAILED DESCRIPTION OF THE EMBODIMENTS

In order to make the objectives, features, and advantages of the present disclosure more obvious and understandable, the technical solutions in the examples of the present disclosure will be described clearly and completely below in conjunction with the accompanying drawings in the examples of the present disclosure. It is apparent that the examples described herein below are only a part, but not all of the examples of the present disclosure. All other examples obtained by those of ordinary skill in the art based on the examples of the present disclosure without creative work are within the protection scope of the present disclosure.

In the description of the present disclosure, it should be understood that the orientation or position relationship indicated by the term “upper”, “lower”, “top”, “bottom”, “inner”, “outer” or the like is the orientation or position relationship based on the accompanying drawings. It is only for the convenience of describing the present disclosure and simplifying the description, rather than indicating or implying that the device or element referred to must have a specific orientation or be constructed and operated in a specific orientation, and therefore cannot be understood as a limitation to the present disclosure. It should be noted that when a component is considered to be “connected” to another component, it may be directly connected to the another component or there may be a component arranged therebetween.

The technical solutions of the present disclosure will be further described below with reference to the accompanying drawings and through specific embodiments.

An example of the present disclosure provides a NASICON-type fluorophosphate with a molecular formula Na₃MₓV₂N_{y}P_{3-y}O₁₂F_{z}. M is at least one of Li, Na, K, Ni, Fe, Ca, Ti, Cr, Zn, Ag, Mo, Mg and Mn. N is at least one of B, Si, Ge and As. 0≤y≤3, 0≤z≤1, 0≤x≤4, and x=y+z.

It should be noted that Li, Na, K, Ni, Fe, Ca, Ti, Cr, Zn, Ag, Mo, Mg and Mn are active metal elements. The synergy of M, N and F can improve the electrochemical performance and structural stability of the material, promote transport efficiency of sodium ions, improve the rate performance of the material, and excite the redox reaction of anions of the material during the charge/discharge process, thereby effectively improving the energy density and power density of the material.

The NASICON-type fluorophosphate of this example provides a new direction for the optimal design of electrode materials, and has broad application prospects, which is conducive to improve the actual capacity and high-rate cycling performance of the battery system.

Optionally, in a specific embodiment, when M is Li, N is Si.

### Example 1

This example provides a method for preparing a NASICON-type fluorophosphate, including the following steps:
S01: uniformly mixing a pentavalent vanadium salt, a sodium salt, an M-containing compound, an N-containing compound, a phosphate and a fluoride salt in a container to form a mixture; and
S02: exposing the mixture to a reducing gas, and carrying out plasma heating on the mixture to obtain the NASICON-type fluorophosphate with a molecular formula Na₃MₓV₂N_{y}P_{3-y}O₁₂F_{z}. M is at least one of Li, Na, K, Ni, Fe, Ca, Ti, Cr, Zn, Ag, Mo, Mg and Mn. N is at least one of B, Si, Ge and As. 0≤x≤4, 0≤y≤3, 0≤z≤1, and x=y+z.

Specifically, the NASICON-type fluorophosphate prepared in this example was Na₃Li_{0.8}V₂Si_{0.5}P_{2.5}O₁₂F_{0.3}. Ammonium metavanadate, sodium dihydrogen phosphate, lithium fluoride and silicon oxide were mixed according to a mole ratio of 2:3:0.8:0.5 and placed in a glass container, heated in a water bath at a low temperature of 120° C. for 2.5 h by using an organic solvent ethanol, and heated and dried at low temperature while mixing, thereby obtaining a precursor material. The dried precursor material was quickly transferred into a low-temperature plasma heating furnace while introducing a reducing gas including hydrogen and argon in a volume ratio of 5:95 into the furnace. Then, the precursor material was heated at a rate of 4° C./min to 350° C., held for 1.5 h, heated to 915° C., and held for 10.5 h, thereby obtaining the Na₃Li_{0.8}V₂Si_{0.5}P_{2.5}O₁₂F_{0.3}. It should be noted that the sodium dihydrogen phosphate is both a sodium salt and a phosphate.

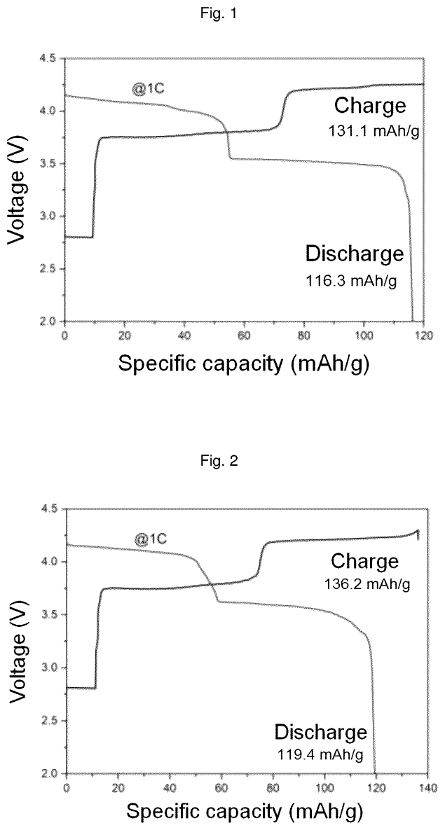

FIG. 1 is a curve graph of an initial capacity of a battery prepared by using this material when tested at a current density of 1 C. As shown in the figure, an initial specific capacity of 116.3 mAh/g was achieved within a voltage range of 2.0 to 4.2 V, indicating excellent conductivity of the material.

It should be noted that the ammonium metavanadate, the sodium dihydrogen phosphate, the lithium fluoride and the silicon oxide may be uniformly mixed by liquid-phase mixing or solid-phase mixing.

The liquid-phase mixing is to mix the ammonium metavanadate, the sodium dihydrogen phosphate, the lithium fluoride and the silicon oxide while heating in a low-temperature water bath.

The solid-phase mixing is to stir the ammonium metavanadate, the sodium dihydrogen phosphate, the lithium fluoride and the silicon oxide by ball milling.

It should be further noted that the reducing gas included nitrogen, hydrogen and a protective gas, and the protective gas includes at least one of helium, neon and argon.

A volume percentage of the hydrogen was greater than 0% and smaller than or equal to 15%, and a volume percentage of the protective gas was greater than or equal to 85% and smaller than 100%.

### Example 2

An Na₃Li_{0.8}V₂Si_{0.5}P_{2.5}O₁₂F_{0.3}@C material was prepared, including:
(1) Ammonium metavanadate, sodium dihydrogen phosphate dihydrate, lithium fluoride, silicon oxide and an additive were mixed according to a mole ratio of 2:3:0.8:0.5:0.15 to form a mixture. The additive was a mixture of glucose and amino acid, or a mixture of sucrose and citric acid.
(2) The mixture was placed in a glass container, heated in a water bath at a low temperature of 120° C. for 2.5 h by using an organic solvent ethanol, and heated and dried at low temperature while mixing, thereby preparing a precursor material. The dried precursor material was quickly transferred into a low-temperature plasma heating furnace while introducing a reducing gas including hydrogen and argon in a volume ratio of 5:95 into the furnace. Then, the precursor material was heated at a rate of 4° C./min to 350° C., held for 1.5 h, heated to 915° C., and held for 10.5 h.

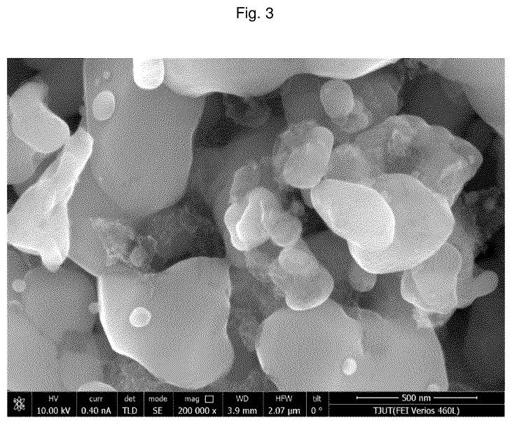

This example is different from Example 1 mainly in that the additive was added during the uniform mixing in step (1), and the rest is the same as in Example 1. In this way, the desired Na₃Li_{0.8}V₂Si_{0.5}P_{2.5}O₁₂F_{0.3}@C material was obtained. The Na₃Li_{0.8}V₂Si_{0.5}P_{2.5}O₁₂F_{0.3}@C material has a carbon coating, and the amino acid and the citric acid have a complexing effect, which can improve transport efficiency of ions. FIG. 2 shows first-cycle charge/discharge curves of a battery prepared from this material at a current density of 1 C. The discharge specific capacity was up to 119.4 mAh/g, and the coulombic efficiency was 87.67%, indicating Improved electrochemical performance of the battery. FIG. 3 is an SEM image of the Na₃Li_{0.8}V₂Si_{0.5}P_{2.5}O₁₂F_{0.3}@C material. As can be seen from the figure, the material is tightly wrapped by the carbon coating, which provides a solid foundation for good actual electrochemical performance.

### Example 3

An Na_{3.5}V₂Si_{0.3}P_{2.7}O₁₂F_{0.2} material was prepared, including:

Ammonium metavanadate, sodium dihydrogen phosphate, sodium fluoride and silicon oxide were mixed according to a mole ratio of 2:3.5:0.2:0.3 and placed in a glass container.

The mixture was heated in a water bath at a low temperature of 120° C. for 2.5 h by using an organic solvent ethanol, and heated and dried at low temperature while mixing, thereby preparing a precursor material. The dried precursor material was transferred into a low-temperature plasma heating furnace while introducing a proper proportion of protective gas including hydrogen and argon in a volume ratio of 5:95 into the furnace. The precursor material was heated at a rate of 4° C./min to 350° C., held for 1.5 h, heated to 915° C., and held for 10.5 h. A pouch battery, prepared by using the prepared material as a cathode, a hard carbon material as an anode, and 1 M sodium hexafluorophosphate dissolved in a solution of EC and DMC in a volume ratio of 1:1 as a standard electrolyte, was tested at a current density of 1 C. An initial specific capacity of 118.2 mAh/g was achieved within a voltage range of 2.0 to 4.2 V.

It should be noted that in this example, M is Na.

### Example 4

A Na₃K_{0.91}V₂B_{0.26}P_{2.74}O₁₂F_{0.65} material was prepared, specifically including:

Ammonium metavanadate, sodium dihydrogen phosphate, potassium fluoride and sodium boride were mixed according to a mole ratio of 2:3:0.91:0.26 and placed in a glass container.

The mixture was heated in a water bath at a low temperature of 120° C. for 2.5 h by using an organic solvent ethanol, and heated and dried at low temperature while mixing, thereby preparing a precursor material. The dried precursor material was quickly transferred into a low-temperature plasma heating furnace while introducing a proper proportion of protective gas including hydrogen and argon into the furnace. The precursor material was heated at a rate of 4° C./min to 350° C., held for 1.5 h, heated to 915° C., and held for 10.5 h. A pouch battery, prepared by using the prepared material as a cathode, a hard carbon material as an anode, and 1 M sodium hexafluorophosphate dissolved in a solution of EC and DMC in a volume ratio of 1:1 as a standard electrolyte, was tested at a current density of 1 C. An initial specific capacity of 116.6 mAh/g was achieved within a voltage range of 2.0 to 4.2 V.

The NASICON-type fluorophosphates of Example 5 to Example 9 in the table below were prepared by similar methods by adjusting proportions of different metal salts and fluorides doped. Sodium-ion batteries prepared by using these materials were subjected to large-scale tests, the performance of the sodium-ion batteries is shown in table below.

TABLE 1
Main parameters of examples and performance of sodium-ion batteries

| | | Discharge | | | | |
|---|---|---|---|---|---|---|
| | | specific | | | | |
| | | capacity | First | | | |
| | | at current | coulombic | High-rate performance | | |
| | | density 1 C | efficiency | 5/C | 10 C | 20 C |
| Example | Molecular formula | (mAh/g) | % | (mAh/g) | (mAh/g) | (mAh/g) |
| Example 1 | Na₃Li_{0.8}V₂Si_{0.5} | 116.3 | 88.71 | 112.5 | 105 | 98.6 |
| | P_{2.5}O₁₂F_{0.3} | | | | | |
| Example 2 | Na₃Li_{0.8}V₂Si_{0.5} | 119.4 | 87.67 | 115.6 | 110.23 | 105.8 |
| | P_{2.5}O₁₂F_{0.3}@ C | | | | | |
| Example 3 | Na_{3.5}V₂Si_{0.3}P_{2.7} | 115.2 | 86.55 | 111.8 | 104.56 | 97.1 |
| | O₁₂F_{0.2} | | | | | |
| Example 4 | Na₃K_{0.91}V₂B_{0.26} | 116.6 | 87.21 | 110.47 | 106.2 | 96.5 |
| | P_{2.74}O₁₂F_{0.65} | | | | | |
| Example 5 | Na₃Li_{0.5}V₂Si_{0.2} | 95.24 | 64.5 | 90.6 | 83.58 | 75.2 |
| | P_{2.8}O₁₂F_{0.3} | | | | | |
| Example 6 | Na₃Li_{0.5}V₂Si_{0.2} | 98.36 | 76.88 | 92.9 | 83.4 | 75.38 |
| | P_{2.8}O₁₂F_{0.3}@ C | | | | | |
| Example 7 | Na₃K_{0.5}V₂Si_{0.3} | 99.56 | 71.02 | 93.5 | 85.26 | 73.5 |
| | P_{2.7}O₁₂F_{0.2} | | | | | |
| Example 8 | Na₃K_{0.91}V₂B_{0.26} | 117.6 | 87.3 | 110.5 | 107.6 | 97.5 |
| | P_{2.74}O₁₂F_{0.65}@ C | | | | | |
| Example 9 | Na₃Li₄V₂Si₃O₁₂F | 87.69 | 67.21 | 80.58 | 70.24 | 68.88 |
| Comparative | Na₃V₂(PO₄)₃ | 86.8 | 60.58 | 80.48 | 72.14 | 66.23 |
| Example | | | | | | |

As can be seen from the data above, all the NASICON-type fluorophosphates of Example 1 to Example 9 are better than Na₃V₂(PO₄)₃ in the comparative example in the aspects of discharge capacity, first coulombic efficiency and high-rate performance, which helps in improving transport efficiency of sodium ions, improves the rate performance of the sodium-ion battery, and excites the redox reaction of anions of the material during the charge/discharge process, thereby effectively improving the energy density and power density of the sodium-ion batteries.

By comparing Example 1 with Example 2, and Example 4 with Example 8, as can be seen, the discharge capacity, the first coulombic efficiency and the high-rate performance of the sodium-ion batteries prepared from the carbon-coated NASICON-type fluorophosphates are improved, but not significantly.

In addition, according to Example 1 and Example 5, for the Na₃LiₓV₂Si_{y}P_{3-y}O₁₂F_{z} type fluorophosphate, when z=0.3, the closer x is to 0.8, the better the electrochemical performance of the sodium-ion battery can be improved. According to Example 2 and Example 6, for the Na₃LiₓV₂Si_{y}P_{3-y}O₁₂F_{z} type fluorophosphate, when z=0.3, the closer x is to 0.8, the better the electrochemical performance of the sodium-ion battery can be improved.

It should be noted that the comparative example is the existing NASICON-type sodium vanadium phosphate material.

Based on the above, the above test data proves that the batteries composed of cathode materials prepared by using the NASICON-type fluorophosphates in this application all have significantly better discharge specific capacity, first coulombic efficiency and high-rate performance, and thus, has significantly better electrochemical performance than the zero-doped NASICON-type sodium vanadium phosphate material in the prior art.

The NASICON-type fluorophosphate in this application can broaden the lattice structure of the material. Moreover, under the synergy of the element M, the element N and the element F, the conductivity and the cycling performance of the sodium-ion batteries are effectively improved, and the conductivity, the first coulombic efficiency and the rate performance of the sodium-ion batteries are further improved, so that the electrochemical performance of the sodium-ion batteries are effectively improved.

As can be seen from the data in the table, when M is Li, x=0.8, y=0.5 and z=0.3, the obtained NASICON-type fluorophosphates have better first coulombic efficiency. For the NASICON-type fluorophosphate tightly wrapped by the carbon coating in Example 2, the discharge specific capacity is improved to some extent.

Specifically, it should be noted that in the actual test process, the molecular formula of pre-alkali metallized materials is determined by ICP testing and actual battery performance testing: [ICP-AES is Inductively Coupled Plasma-Atomic Emission Spectrometry, also known as Inductively Coupled Plasma-Optical Emission Spectrometry (ICP-OES)].

It should also be noted that the assembly and test process of the pouch batteries is as follows:
(1) Weigh in the first step. The prepared NASICON-type fluorophosphate, conductive carbon and PVDF were weighed according to a mass ratio of 94:3:3, dissolved in a certain amount of NMP, stirred, coated, dried, and cut to obtain a cathode electrode plate.
(2) Weigh in the second step. An anode hard carbon material, conductive carbon and CMC/SBR were weighed according to a mass ratio of 85:10:5, dissolved in a certain amount of water, stirred, coated, dried, and cut to obtain an anode electrode plate.
(3) The battery electrode plate adopts a winding process. A separator was wound by 5/6 turns, and then the anode and the cathode were sequentially wound by a total of 8 turns. Finally, the anode was wound as the outermost layer, thereby ensuring the cathode to be completely wrapped by the anode.
(4) Tabs were welded to the jelly roll, and a tape was applied. Then, the wound core was sealed with an aluminum-plastic film, baked in a vacuum oven for 10 to 120 h, taken out, and tested for its water content (the H₂O content should be less than 200 ppm). Then, an electrolyte was added according to a certain dosing coefficient and proportion. After sealing, aging and formation, the battery was subjected to capacity grading. The electrolyte used was 1 M sodium hexafluorophosphate dissolved in a solvent including EC and DMC in a volume ratio of 1:1. The assembled battery was allowed to stand on a LANHE battery tester for 8 h, and then, the testing was started. The battery was charged and discharged at a rate of 1 C. The theoretical specific capacities were 128/370 mAh/g (the capacities were according to the precalculated design). The battery was charged, and then discharged at a current of 0.1 C, and finally, the corresponding capacities were calculated.

The theoretical specific capacity of the cathode was 128 mAh/g, and the theoretical specific capacity of the anode was 370 mAh/g. The actual performance was generally 100 or so (pouch battery). In fact, the cathode prepared in this example had a maximum specific capacity of nearly 120 mAh/g, and had high first coulombic efficiency and better high-rate performance, indicating significantly better electrochemical performance than the NASICON-type sodium vanadium phosphate in the prior art.

In another specific embodiment, disclosed is a cathode. The cathode includes the NASICON-type fluorophosphate prepared by the method according to any of Example 1 to Example 4.

In another specific embodiment, disclosed is a sodium-ion battery, including the cathode as described above.

It should be noted that relational terms such as “first” and “second” herein are only used to distinguish one entity or operation from another entity or operation, and do not necessarily require or imply any such actual relationship or sequence between these entities or operations. Moreover, the terms “comprise”, “include” or any other variation thereof are intended to cover non-exclusive inclusion, so that a process, method, article or equipment including a series of elements includes not only those elements, but also other elements not explicitly listed, or elements inherent to this process, method, article or equipment.

Although the examples of the present disclosure have been shown and described, for those of ordinary skill in the art, it can be understood that various changes, modifications, substitutions and variations can be made to these examples without departing from the principle and spirit of the present disclosure, and the scope of the present disclosure is defined by the appended claims and their equivalents.

The above examples are intended only to illustrate, but not to limit the technical solutions of the present disclosure. Although the present disclosure has been described in detail with reference to the foregoing examples, those of ordinary skill in the art should understand that they can still modify the technical solutions described in the foregoing examples, or equivalently substitute some of the technical features. These modifications and substitutions do not make the essence of the corresponding technical solutions deviate from the spirit and scope of the technical solutions of the examples of the present disclosure.

What is claimed is:

1. A NASICON-type fluorophosphate with a molecular formula Na₃MₓV₂N_{y}P_{3-y}O₁₂F, wherein M is at least one of Li, Na, K, Ni, Fe, Ca, Ti, Cr, Zn, Ag, Mo, Mg and Mn, N is at least one of B, Si, Ge and As, 0≤x≤4, 0≤y≤3, 0≤z≤1, and x=y+z.

2. The fluorophosphate according to claim 1, wherein the NASICON-type fluorophosphate is further coated with carbon to obtain a material Na₃MₓV₂N_{y}P_{3-y}O₁₂F_{z}@C.

3. A method for preparing a NASICON-type fluorophosphate, comprising the following steps:
S01: uniformly mixing a pentavalent vanadium salt, a sodium salt, an M-containing compound, an N-containing compound, a phosphate and a fluoride salt in a container to form a mixture; and
S02: exposing the mixture to a reducing gas, and carrying out plasma heating on the mixture to obtain the NASICON-type fluorophosphate with a molecular formula Na₃MₓV₂N_{y}P_{3-y}O₁₂F_{z}; wherein M is at least one of Li, Na, K, Ni, Fe, Ca, Ti, Cr, Zn, Ag, Mo, Mg and Mn, N is at least one of B, Si, Ge and As, 0≤x≤4, 0≤y≤3, 0≤z≤1, and x=y+z.

4. The method according to claim 3, wherein in step S01, a mole ratio of the pentavalent vanadium salt to the sodium salt to the M-containing compound to the N-containing compound to the phosphate to the fluoride salt is 0.01-2:0.01-3:0.01-1.0.01-3:0.01-3:0.01-1.

5. The method according to claim 3, wherein during the uniform mixing in step S01, an additive is further added to the container, the additive comprising at least one of citric acid, glucose, sucrose, amino acid and urea.

6. The method according to claim 5, wherein the additive comprises glucose and amino acid, and a ratio of the glucose to the amino acid in the additive is 1:0.6-1.5;
or
the additive comprises sucrose and citric acid, and a ratio of the sucrose to the citric acid in the additive is 1:0.5-1.8.

7. The method according to claim 3, wherein the reducing gas comprises nitrogen, hydrogen and a protective gas, the protective gas comprising at least one of helium, neon and argon;
wherein a volume percentage of the hydrogen is greater than 0% and smaller than or equal to 15%, and a volume percentage of the protective gas is greater than or equal to 85% and smaller than 100%.

8. A cathode electrode plate, comprising the NASICON-type fluorophosphate prepared by the method according to claim 3.

9. A sodium-ion battery, comprising the cathode electrode plate according to claim 8.

10. The fluorophosphate according to claim 1, wherein M is at least one of Li and K.

11. The fluorophosphate according to claim 1, wherein N is at least one of Si and B.

12. The fluorophosphate according to claim 1, wherein M is Li, N is Si.

13. The fluorophosphate according to claim 1, wherein 0.5≤x≤4, 0.2≤y≤3, 0.2≤z≤1, and x=y+z.

14. The fluorophosphate according to claim 1, wherein 0.5≤x≤0.91, 0.2≤y≤0.5, 0.2≤z≤0.65, and x=y+z.

15. The fluorophosphate according to claim 1, wherein the fluorophosphate is Na₃Li_{0.8}V₂Si_{0.5}P_{2.5}O₁₂F_{0.3}, Na_{3.5}V₂Si_{0.3}P_{2.7}O₁₂F_{0.2}, Na₃K_{0.91}V₂B_{0.26}P_{2.74}O₁₂F_{0.65}, Na₃Li_{0.5}V₂Si_{0.2}P_{2.8}O₁₂F_{0.3}, Na₃K_{0.5}V₂Si_{0.3}P_{2.7}O₁₂F_{0.2} or Na₃Li₄V₂Si₃O₁₂F.

16. The fluorophosphate according to claim 2, wherein the fluorophosphate is Na₃Li_{0.8}V₂Si_{0.5}P_{2.5}O₁₂F_{0.3}@C, Na₃Li_{0.5}V₂Si_{0.2}P_{2.8}O₁₂F_{0.3}@C or Na₃K_{0.91}V₂B_{0.26}P_{2.74}O₁₂F_{0.65}@C.
